(19) United States
(12) Patent Application Publication
(10) Pub. No.: US 2019/0164206 A1
(43) Pub. Date: May 30, 2019

(54) HIGH VALUE TRANSACTIONAL EVENTS FROM SOCIAL SIGNALS

(71) Applicant: Element Data, Inc., Seattle, WA (US)

(72) Inventors: Viswanath Vadlamani, Sammamish, WA (US); Phani Vaddadi, Bellevue, WA (US); Charles F. L. Davis, III, Elk Grove, CA (US); Cyrus Krohn, Issaquah, WA (US)

(21) Appl. No.: 15/826,519

(22) Filed: Nov. 29, 2017

(51) Int. Cl. G06Q 30/06; G06Q 50/00; G06N 5/04

(52) U.S. Cl. CPC G06Q 30/0613; G06Q 30/0635; G06N 5/04; G06Q 50/01

(57) ABSTRACT

Aspects of the present disclosure identify social media conversational signals and deliver prospects of potential opportunities to conduct a sale in an automated fashion. Individuals, or groups of people, are identified who are in decision making mode, and the communications are presented to businesses and/or organizations to help complete the transaction. Unlike social listening platforms, which use keyword matching and sentiment analysis, in some embodiments this platform leverages machine learning (ML), natural language processing (NLP) and the Universal Human Relevance System (UHRS) to identity relevant results by classifying them into a domain specific taxonomy. These transactional events may be defined by the date and time stamp, what the potential customer is looking for, the time-frame for consideration of the purchase, and the geographic location of the individual at the time of the signal's publication. In addition, these transactional events can be customized to suit the context of a domain.

### TECHNICAL FIELD

The subject matter disclosed herein generally relates to processing data. In some example embodiments, the present disclosures relate to methods for determining high value transactional events from social signals.

### BACKGROUND

Social listeners are tools that allow users to build keyword queries and monitor conversations that are relevant to those keywords. They depend heavily on user knowledge and expertise in the domain. Social listeners and similar tools attempt to offer users user information that may be actionable, but oftentimes struggle to achieve this. Various tools, such as social media listeners and monitors, produce a lot of data that is noisy and of low relevance, in that most information picked up by these tools do not provide actionable information, even when they are based on keywords. Furthermore, currently, most of the conventional tools specialize in sentiment detection and analysis, and fail to provide more fine-tuned classification.

In other cases, leading tools focus on acquiring user profile data and perform aggregate analysis and look alike modelling, in order to provide a user with relevant and potentially useful information. Still, this kind of information serves mostly as just an approximation or a proxy that infers or suggests that such information might be useful. Many times, such inferences are not accurate. It is desirable to improve engines for monitoring the thousands or even millions of human communications to more reliably and intelligently find information that can be acted upon.

### BRIEF SUMMARY

In some embodiments, methods and systems are presented for accurately identifying high value transactional events out of a large amount of human communications, using computer technology that analyzes the human communications and identifies a very refined subset of them as relevant, and then categorizes this subset into actionable data for a user to easily and effectively act upon.

In some embodiments, a method for determining a high value transactional event communication is presented. The method may include: accessing, by an artificial intelligence engine, a plurality of human communications streaming in real time or near-real time; evaluating, by the artificial intelligence engine, each human communication among the plurality of human communications for relevance to an industry-specific domain evaluating, by the artificial intelligence engine, each human communication that is relevant to the industry-specific domain for an expression of intent to conduct a monetary transaction; and causing display of each human communication that is relevant to the industry-specific domain and satisfies a valid expression of intent to conduct a monetary transaction.

In some embodiments, the method further includes discarding, from further evaluation, by the artificial intelligence engine, each human communication that is determined to not be relevant to the industry-specific domain.

In some embodiments, the method further includes discarding, from further evaluation, by the artificial intelligence engine, each human communication that is determined to not express an intent to conduct a monetary transaction.

In some embodiments, the method further includes evaluating, by the artificial intelligence engine, each human communication that satisfies a valid expression of intent to conduct a monetary transaction for a purchase time frame indicating an approximate time period for when the monetary transaction is intended to be conducted; and wherein causing the display of each human communication is based further on each human communication satisfying a valid purchase time frame. In some embodiments, the method further includes discarding, from further evaluation, by the artificial intelligence engine, each human communication that is determined to not satisfy a valid purchase time frame.

In some embodiments, the method further includes evaluating, by the artificial intelligence engine, each human communication that satisfies a valid expression of intent to conduct a monetary transaction for a geographic location indicating an approximate geographic location for where the monetary transaction is intended to be conducted; and wherein causing the display of each human communication is based further on each human communication satisfying a valid geographic location.

In some embodiments, the method further includes discarding, from further evaluation, by the artificial intelligence engine, each human communication that is determined to not express a valid geographic location.

In some embodiments, an apparatus for determining a high value transactional event communication is presented. The apparatus may include a memory and a processor communicatively coupled to the memory. The processor may be configured to: access a plurality of human communications streaming in real time or near-real time; evaluate each human communication among the plurality of human communications for relevance to an industry-specific domain; evaluate each human communication that is relevant to the industry-specific domain for an expression of intent to conduct a monetary transaction; and cause display of each human communication that is relevant to the industry-specific domain and satisfies a valid expression of intent to conduct a monetary transaction.

### BRIEF DESCRIPTION OF THE DRAWINGS

Some embodiments are illustrated by way of example and not limitation in the figures of the accompanying drawings.

FIG. 1 is a network diagram illustrating an example network environment suitable for aspects of the present disclosure, according to some example embodiments.

FIG. 2 shows one example of a human communication that an engine or platform of the present disclosure may be configured to analyze and classify as being a high value transactional event.

FIGS. 3A-3B show examples of high value transactional events being displayed to a user.

FIG. 3A shows an example display output for a single high value transactional event related to the auto industry domain.

FIG. 3B shows another example of a high value transaction event, this time in the travel domain.

FIG. 4 shows an expanded example of multiple high value transactional events, this time in the Movies and Shows Domain.

FIG. 5 shows additional customizable action tags that may be applied to any high value transactional event.

FIG. 6 provides a flowchart of an example methodology performed by an engine of the present disclosure for conducting Conversational Understanding to identify high value transactional events, according to some embodiments.

FIG. 7 is a block diagram illustrating components of a machine, according to some example embodiments, able to read instructions from a machine-readable medium and perform any one or more of the methodologies discussed herein.

### DETAILED DESCRIPTION

Example methods, apparatuses, and systems (e.g., machines) are presented for accurately identifying high value transactional events out of a large amount of human communications, using computer technology that analyzes the human communications and identifies a very refined subset of them as relevant, and then categorizes this subset into actionable data for a user to easily and effectively act upon.

In some embodiments, a specialized natural language processing (NLP) engine first gathers millions of human communications, but rather than categorizes all of them into various classifications, mines the entire body for specific communications that can be actionable to a customer using the NLP engine (e.g., a marketing manager or a sales representative trying to find social media communications from humans that are much more likely to act upon a specific offer that addresses their desired need expressed in said social media communication). These kinds of human communications may be referred to herein as “high value transactional events,” in that each of these human communications provides at least one indication that the human is more likely to engage in a specific offer that addresses the need expressed in the communication, thereby suggesting the communication has a high monetary value or otherwise. The particular process of mining for these high value transactional events may be referred to herein as “conversational understanding” as performed by computer technology. To do this, the engine determines whether a communication contains specific contextual information that indicates the person expressing the communication is intent on conducting an action. For example, the engine determines whether the communication expresses an intent or desire to make a purchase, and whether there is an intent or desire to do so within a particular time frame. In some embodiments, the engine may determine a geographic location of where the person intends to perform the action. This geographic information may be used to focus a customer on only those communications that fall within a particular geographic area. Conversational understanding is generally domain agnostic, but may typically be applied to a domain specific taxonomy that a user or customer is particularly interested in, such as particular types of movies, clothes, or cars.

The large volume of messages on social networks or other corpuses, when passed thru a Conversational Understanding lens, yields a robust set of high value transactional events that can be monetized effectively. Enrichment of the message profile data provides a way to further enhance the quality of the outcomes. In some embodiments, the profiles of the mined communications, along with event data, are published to marketplace or customer specified IT systems. These results may be displayed in an orderly fashion.

In some embodiments, the events, i.e., the communications being analyzed and mined for and the results derived therefrom, can be replied to in context in near real time. Customizable action tags enables for a sophisticated interaction with the event.

In general, aspects of the present disclosure identify social media conversational signals and deliver prospects of potential opportunities to conduct a sale in an automated fashion. Individuals, or groups of people, are identified who are in decision making mode, and the communications are presented to businesses and/or organizations to help complete the transaction. Unlike social listening platforms, which use keyword matching and sentiment analysis, in some embodiments this platform leverages machine learning (ML), natural language processing (NLP) and the Universal Human Relevance System (UHRS) to identity relevant results by classifying them into a domain specific taxonomy. These transactional events may be defined by the date and time stamp, what the potential customer is looking for, the time-frame for consideration of the purchase, and the geographic location of the individual at the time of the signal's publication. In addition, these transactional events can be customized to suit the context of a domain.

As briefly alluded to, known techniques for classifying human communications using natural language processing differ in several respects compared to aspects of the present disclosure. For example, conventional classification engines are designed to classify all communications into one or more categories. In contrast, the engine of the present disclosure performs conversational understanding by first determining whether each communication is actionable, and if so, then classifying only the actionable communications into relevant designations. In other words, an engine of the present disclosure mines the thousands or millions of communications for only specific types of content and effectively discards or ignores the rest. In addition, the method for determining whether a communication is actionable utilizes natural language processing to determine specific categories, such as an intent to purchase (“PurchaseIntent”) and a specific time to purchase (“PurchaseTime”). The engine is also capable of determining more contextual information that is practicable for a customer to utilize for helping to reach relevant potential purchasers.

Examples merely demonstrate possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

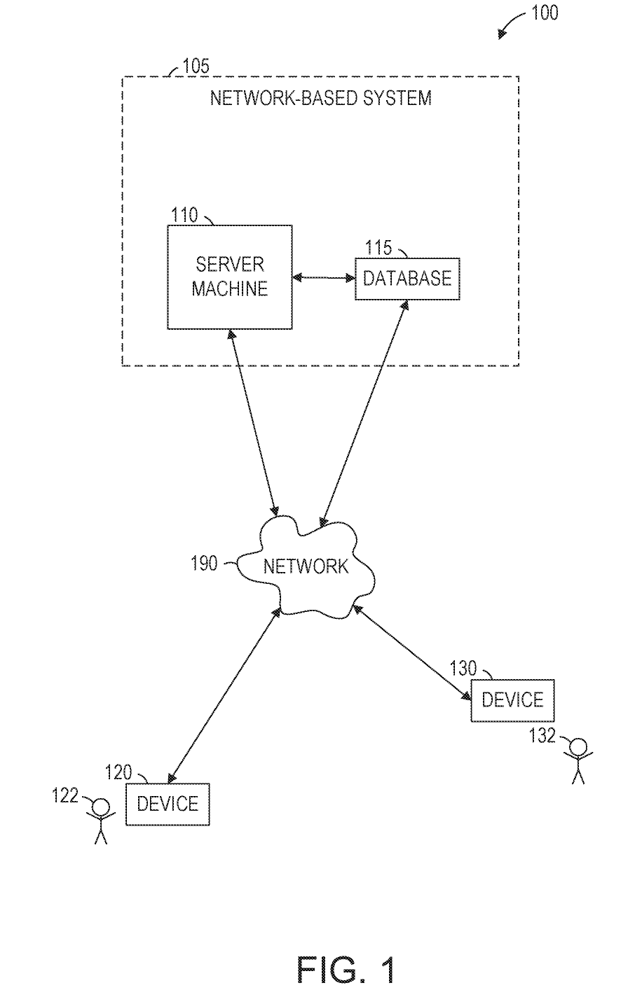

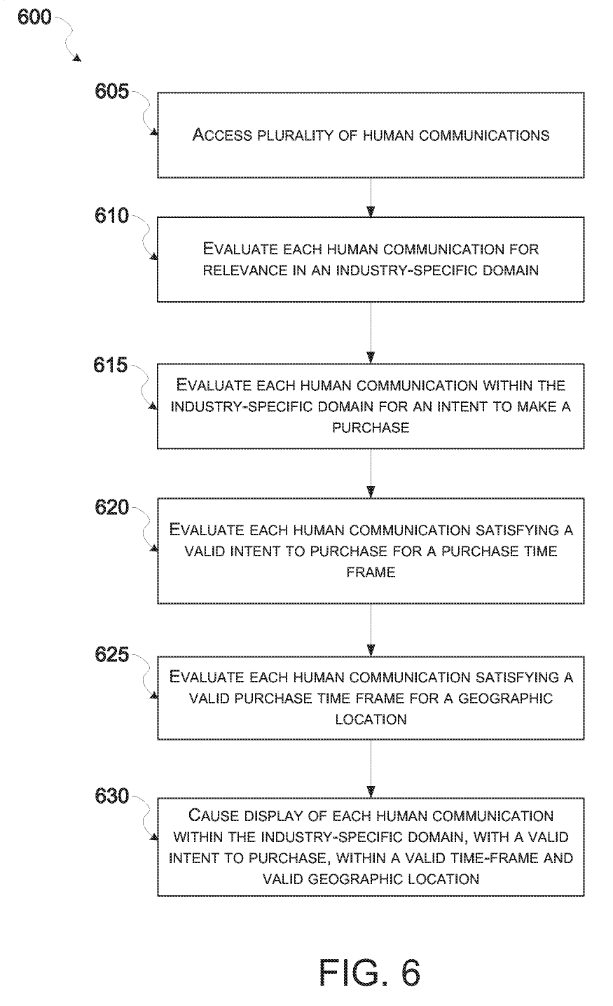

Referring to FIG. 1, a network diagram illustrating an example network environment 100 suitable for performing aspects of the present disclosure is shown, according to some example embodiments. The example network environment 100 includes a server machine 110, a database 115, a first device 120 for a first user 122, and a second device 130 for a second user 132, all communicatively coupled to each other via a network 190. The server machine 110 may form all or part of a network-based system 105 (e.g., a cloud-based server system configured to provide one or more services to the first and second devices 120 and 130). The server machine 110, the first device 120, and the second device 130 may each be implemented in a computer system, in whole or in part, as described below with respect to FIG. 6. The network-based system 105 may be an example of an NLP engine or platform for identifying high value transactional events as described herein. The server machine 110 and the database 115 may be components of the high value transactional event engine configured to perform these functions. While the server machine 110 is represented as just a single machine and the database 115 where is represented as just a single database, in some embodiments, multiple server machines and multiple databases communicatively coupled in parallel or in serial may be utilized, and embodiments are not so limited.

Also shown in FIG. 1 are a first user 122 and a second user 132. One or both of the first and second users 122 and 132 may be a human user, a machine user (e.g., a computer configured by a software program to interact with the first device 120), or any suitable combination thereof (e.g., a human assisted by a machine or a machine supervised by a human). The first user 122 may be associated with the first device 120 and may be a user of the first device 120. For example, the first device 120 may be a desktop computer, a vehicle computer, a tablet computer, a navigational device, a portable media device, a smartphone, or a wearable device (e.g., a smart watch or smart glasses) belonging to the first user 122. Likewise, the second user 132 may be associated with the second device 130. As an example, the second device 130 may be a desktop computer, a vehicle computer, a tablet computer, a navigational device, a portable media device, a smartphone, or a wearable device (e.g., a smart watch or smart glasses) belonging to the second user 132. The first user 122 and a second user 132 may be examples of users or customers interfacing with the network-based system 105 to identify high value transactional events. The users 122 and 132 may interface with the network-based system 105 through the devices 120 and 130, respectively.

Any of the machines, databases 115, or first or second devices 120 or 130 shown in FIG. 1 may be implemented in a general-purpose computer modified (e.g., configured or programmed) by software (e.g., one or more software modules) to be a special-purpose computer to perform one or more of the functions described herein for that machine, database 115, or first or second device 120 or 130. For example, a computer system able to implement any one or more of the methodologies described herein is discussed below with respect to FIG. 6. As used herein, a “database” may refer to a data storage resource and may store data structured as a text file, a table, a spreadsheet, a relational database (e.g., an object-relational database), a triple store, a hierarchical data store, any other suitable means for organizing and storing data or any suitable combination thereof. Moreover, any two or more of the machines, databases, or devices illustrated in FIG. 1 may be combined into a single machine, and the functions described herein for any single machine, database, or device may be subdivided among multiple machines, databases, or devices.

The network 190 may be any network that enables communication between or among machines, databases 115, and devices (e.g., the server machine 110 and the first device 120). Accordingly, the network 190 may be a wired network, a wireless network (e.g., a mobile or cellular network), or any suitable combination thereof. The network 190 may include one or more portions that constitute a private network, a public network (e.g., the Internet), or any suitable combination thereof. Accordingly, the network 190 may include, for example, one or more portions that incorporate a local area network (LAN), a wide area network (WAN), the Internet, a mobile telephone network (e.g., a cellular network), a wired telephone network (e.g., a plain old telephone system (POTS) network), a wireless data network (e.g., WiFi network or WiMax network), or any suitable combination thereof. Any one or more portions of the network 190 may communicate information via a transmission medium. As used herein, “transmission medium” may refer to any intangible (e.g., transitory) medium that is capable of communicating (e.g., transmitting) instructions for execution by a machine (e.g., by one or more processors of such a machine), and can include digital or analog communication signals or other intangible media to facilitate communication of such software.

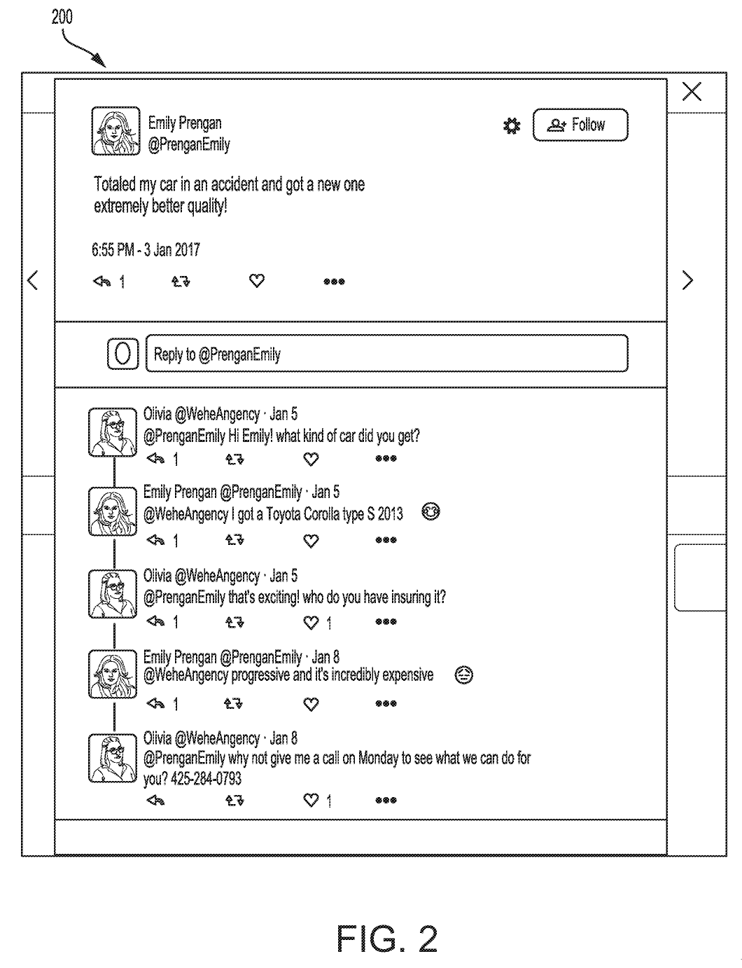

Referring to FIG. 2, illustration 200 shows one example of a human communication that an engine or platform of the present disclosure, such as the network based system 105, may be configured to analyze and classify as being a high value transactional event. Shown here is a tweet from an ordinary user, expressing “Totaled my car in an accident and got a new one extremely better quality!” At the time of this tweet, it is apparent that the user already has a new car. Thus, while an opportunity to sell this user a new car may no longer be available, other transactional opportunities may be apparent, such as new insurance that may fit better for the user and the new type of car she bought. Illustration 200 shows an exchange between the user and a sales representative who may have utilized the engine of the present disclosure to determine that this communication may be a high transactional event. Shortly after the initial tweet was posted, the sales representative contacted the twitter user and inquired about whether she was satisfied with her insurance. The sales representative may have been made aware of the time sensitive nature of the opportunity through indicators provided by the engine. In addition, the sales representative may have been made aware of this particular post based on a geographic determination of the location of the user. That is, the user may have been in a coverage range that the car insurance covers.

Other social media communications may be identified in a similar manner using an engine of the present disclosure. For example, messages expressing a need for help that a service or product can satisfy may represent high value transaction events that are actionable. For example, a user on Twitter may reach out to her followers about advice to handle a rodent infestation in her home. As another example, a social media user may ask on social media for recommendations for a type of restaurant or local takeout food. As another example, a social media user may express frustration with a slow or malfunctioning laptop, and ask friends for a recommendation on what new computer to buy.

In contrast, not all human communications on social media are actionable. For example, a user on social media merely stating that “local sports team is utter garbage!” is expressing a feeling that does not suggest that there is an obvious, contemporary monetary opportunity. As another example, tweeting about a review of a movie, while related to an actual transactional event, may not rise to the level of representing a high probability of selling a product or service to the user. This is because there may be a difference between suggesting a product that might be inferentially related to the expressed topic on social media, and offering a product or service that directly addresses an expressed need or other intent to purchase something. In general, techniques for natural language processing may train The engine of the present disclosure may be configured to evaluate every message it comes across, but only present the high value transactional events to a user of the engine. This initial “mining” phase may result in thousands or even millions of messages being acquired and initially evaluated, but only very few being actually presented to a user of the engine as potentially actionable. The vast majority of the communications will not be classified, unlike conventional NLP engines.

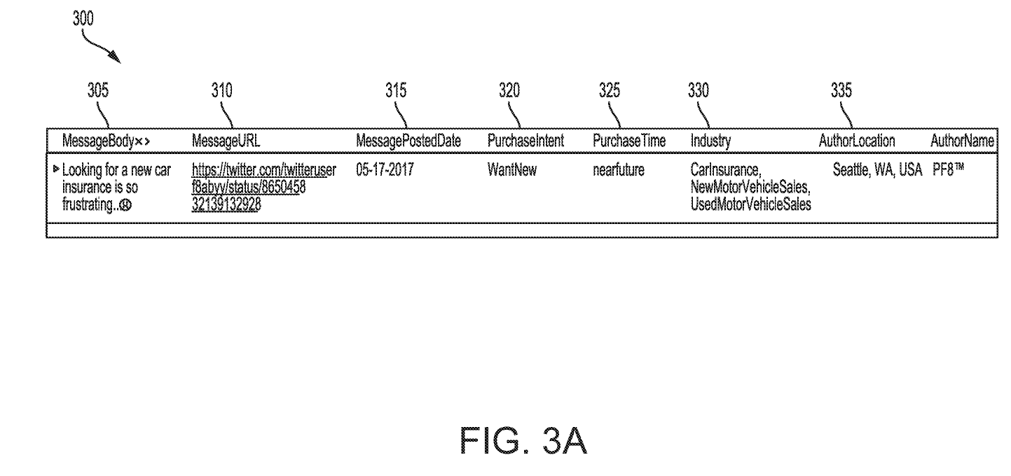

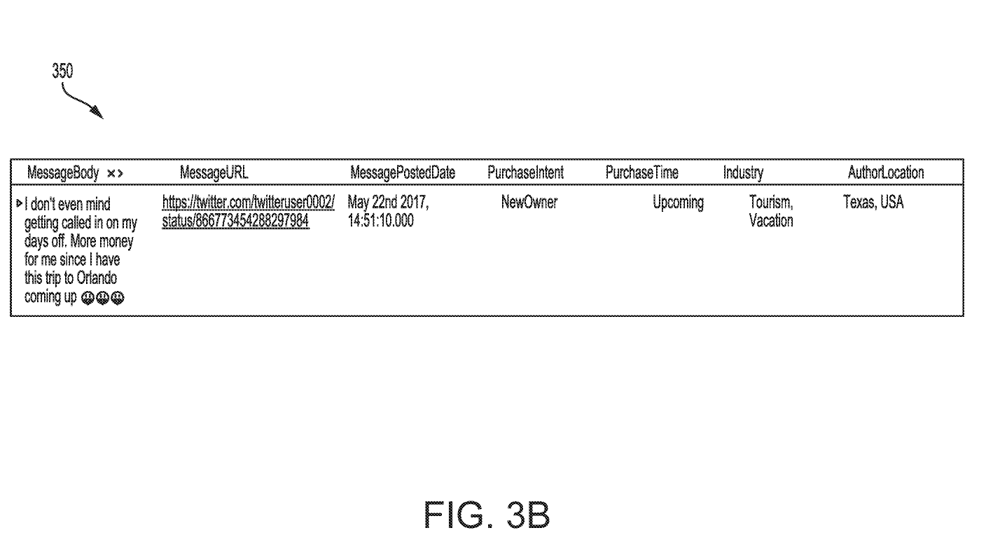

Referring to FIG. 3A, illustration 300 shows an example display output for a single high value transactional event. This string of information may be displayed to a user, such as user 122 or 132, of the NLP engine of the present disclosure. Here, the output shows the message body 305 that is the content of the human communication expressed on social media. For a direct link to the actual message, the user can refer to the link 310. A time stamp 315 for which the original message was posted is also shown. Also shown are various categories used to provide additional context for the high value transactional event. For example, the “PurchaseIntent” label 320 confirms that the engine has interpreted the human communication to have an affirmative intent to purchase, and describes further that the intent is “WantNew,” meaning there is an inference the potential customer wants a new item to be purchased. The label “PurchaseTime” 325 describes an interpretation by the engine of when the potential customer would like to make a purchase. In this case, it is expressed as “nearfuture.” The “Industry” label 330 shows want types of industries this message may be relevant to. Here, several categories, such as “Carinsurance,” “NewMotorVehicleSales,” and “UsedMotorVehicleSales” are supplied. Furthermore, an “AuthorLocation” label 335 is supplied, to provide geographical context for determining how feasible this potential customer may be reached.

To determine a high transactional event, the engine of the present disclosure may use one or more categories, such as labels 320, 325, 330, and 335, as contextual “filters” to determine whether the original message meets certain thresholds according to those categories. For example, the engine of the present disclosure may first evaluate any human communication, using NLP and other techniques in the AI space, to determine whether there is an intent to purchase (i.e., satisfies a valid category in the “PurchaseIntent” label 320) a product or a service. If the answer is no, then the message may be automatically discarded. If the answer is yes, further descriptive information about the item to be purchased, e.g., new, used, low cost, etc., may be determined and displayed in a display like in illustration 300. Next, additional contextual “filters” may be conducted for any human communication that passes the first contextual filter. Examples include any of the labels 325, 330, 335, and others. The engine may continue to evaluate the message in question using NLP and other techniques in the AI space, according to each specified context filter in sequence. A user of the engine may specify only certain valid contextual answers as qualifying as high value transactional events. For example, the user of the engine may specify that only messages having a purchase time in the near future are valid, or that messages originating from a certain geographic area are valid.

Referring to FIG. 3B, illustration 350 shows another example of a high value transaction event, this time in the travel domain. As before, the message body and other contextual information is displayed for a user interested in knowing what opportunities are available to monetize communications related to travel. This message says “I don't even mind called in on my days off. More money for me since I have this trip to Orlando coming up (triple smiley emojis).” The potential customer has expressed an intent to travel to Orlando, in an “upcoming” timeframe, on what is likely for vacation/tourism purposes. A user of the engine of the present disclosure may decide to act on this information and offer some solicitations related to this information.

Based on these examples, it may be apparent that the transactional opportunity available to users of aspects of the present disclosure lies in the prospective or future value of events and desired purchases that have yet to happen. This is in stark contrast to known methods for trying to display relevant ads to potential customers based on past events, such as a purchase history or search history on a personal computer. While it is well known that various meta data, such as cookies, can be relied upon to offer a potential customer ads of more of the same type of product already purchased, those kinds of ads offerings may already be too late, in that the potential customer may have already bought what he or she was looking for. For example, if the potential customer just bought a television after doing a great amount of research online and asking on social for recommendations, it may be of little value for further ads about televisions to show up days after the television was already bought, as it is not likely the potential customer will keep buying televisions at this time. On the other hand, aspects of the present disclosure focus on contemporary human communications that express an intent to purchase at a future time. This may be particularly relevant to purchases that occur in just a single instance (as what happens often for products and services). This enables a user of the engine to catch the potential customer at the optimal time: exactly when the user is in the market for a particular service or product.

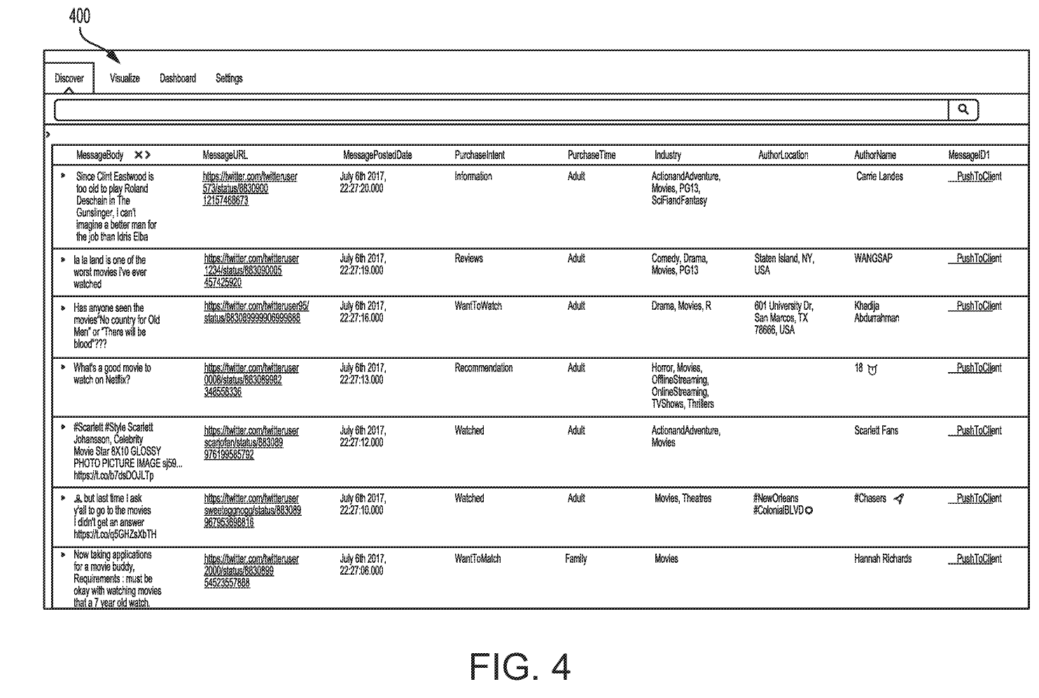

Referring to FIG. 4, illustration 400 shows an expanded example of multiple high value transactional events, this time in the Movies and Shows Domain. As before, the message bodies are displayed that shows the original content. These events may have been mined using various contextual filters, such as “PurchaseIntent,” “Industry” and “AuthorLocation.” With a larger message board of results as shown, a user of the engine may be able to respond to only particular messages.

In some embodiments, evaluating the human communications is based on how the content in social media is classified per domain, according to how the domain experts view their world. A domain taxonomy can be initialized from extraction of content from the web and then curated with experts. The taxonomy may be used to represent the universe of labels that may be applied to any particular human communication in that particular industry. For the taxonomy to be relevant, it can be updated based on changes happening in the real world on a continual basis. In addition, at least part of the taxonomy may be provided by the user of the engine, such as a marketing firm specializing in a particular industry.

The following is an example of a taxonomy used by the engine of the present disclosure to determine which communications may be high value transactional events.

{

“moviesandshows”: {

“agegroup”: {

“type”: “YYY”,
“title”: “AuthorAgeGroup”,
“name”: “AuthorAgeGroup”,
“titles”: [

“undefined”,
“16-24”,
“25-64”,
“Over65”

],
“values”: [

“undefined”,
“16-24”,
“25-64”,
“over65”

]

},
“purchaseintent”: {

“type”: “YYY”,
“title”: “Watching Intent”,
“name”: “PurchaseIntent”,
“titles”: [

“Not Specified”,
“Want to watch”,
“On the Wish List”,
“Recommendation”,
“Reviews”,
“Watched”,
“Information”

],
“values”: [

“NotSpecified”,
“WantToWatch”,
“Wishlist”,
“Recommendation”,
“Reviews”,
“Watched”,
“Information”

]

},
“purchasetime”: {

“type”: “YYY”,
“title”: “Audience Type”,
“name”: “PurchaseTime”,
“titles”: [

“Kids”,
“Youth”,
“Adult”,
“Family”

],
“values”: [

“Kids”,
“Youth”,
“Adult”,
“Family”

]

},
“industry”: {

“type”: “ZZZ”,
“title”: “Industry”,
“name”: “Industry”,
“classes”: [

{

“cname”: “None Specified”,
“titles”: [

“None Specified”

],
“values”: [

“none”

]

},
{

“cname”: “Industry Type”,
“titles”: [

“Movies”,
“TV Shows”,
“Torrent”,
“Advertisement”,
“News”

],
“values”: [

“Movies”,
“TVShows”,
“Torrent”,
“Advertisement”,
“News”

]

},
{

“cname”: “Watching Mode”,
“titles”: [

“Online Link”,
“Offline Streaming”,
“Online Streaming”,
“Youtube”,
“DVDs”,
“BluRay”,
“Stream Live”,
“Theatres”,
“Download”

],
“values”: [

“OnlineLink”,
“OfflineStreaming”,
“OnlineStreaming”,
“Youtube”,
“DVDs”,
“BluRay”,
“StreamLive”,
“Theatres”,
“Download”

]

},
{

“cname”: “Rating”,
“titles”: [

“G”,
“PG”,
“PG13”,
“R”

],
“values”: [

“G”,
“PG”,
“PG13”,
“R”

]

},
{

“cname”: “Movies Genre”,
“titles”: [

“Action and Adventure”,
“Anime”,
“Children and Family”,
“Classic”,
“Comedy”,
“Cult”,
“Documentaries”,
“Drama”,
“Faith and Spirituality”,
“Foreign”,
“Horror”,
“Musicals”,
“Noir”,
“Romantic”,
“Sci - Fi and Fantasy”,
“Sports”,
“Thrillers”,
“History”

],
“values”: [

“ActionandAdventure”,
“Anime”,
“ChildrenandFamily”,
“Classic”,
“Comedy”,
“Cult”,
“Documentaries”,
“Drama”,
“FaithandSpirituality”,
“Foreign”,
“Horror”,
“Musicals”,
“Noir”,
“Romantic”,
“SciFiandFantasy”,
“Sports”,
“Thrillers”,
“History”

]

},
{

“cname”: “TV Shows Genre”,
“titles”: [

“American”,
“British”,
“Crime”,
“Food and Travel”,
“Kids”,
“Military”,
“Science and Nature”,
“Mysteries”,
“Reality”,
“Teens”,
“Game Shows”,
“Talk Shows”

],
“values”: [

“American”,
“British”,
“Crime”,
“FoodandTravel”,
“Kids”,
“Military”,
“ScienceandNature”,
“Mysteries”,
“Reality”,
“Teens”,
“GameShows”,
“TalkShows”

]

}

]

}

}

}

The following are several other examples of high value transactional events in different domains.

In the case of a political campaign, a high value transactional event may be an individual committing to register to vote, or make a financial contribution.

In the case of the travel domain, these could be a person expressing interest to take a vacation to a specific destination.

In the case of the insurance domain, it may be a person with a life changing event like having their child and considering life insurance.

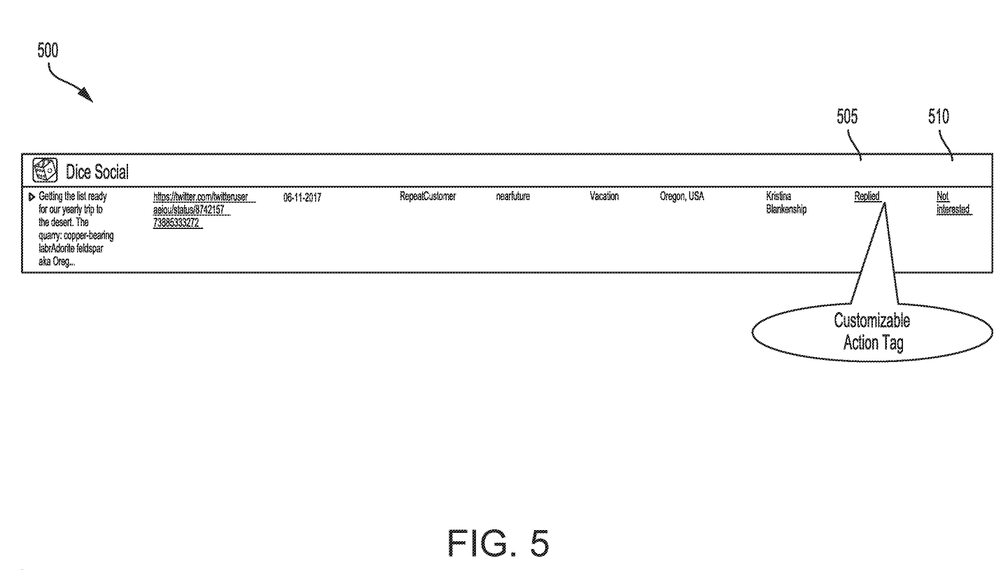

Referring to FIG. 5, in some embodiments, additional customizable action tags may be applied to any high value transactional event. An identified prospect in a social conversation can be replied to in context and the original social conversation is preserved. These prospects are time sensitive and the replies are facilitated in near real time while the prospect is still in the decision making mode. Shown in illustration 500 are two example annotations 505 and 510 that may be applied to the events by a user of the engine. In this case, one tag 505 indicates that the event has been replied to, and the other tag 510 indicates the resolution of the reply, namely, “Not Interested.” Other tags are also possible, such as a subjective ranking as to the potential value of each event (e.g., High probability, Medium probability, Low probability), or urgency of replying to each event (e.g., Urgent, Medium priority, Low priority). In general, every prospect can be associated with a number of customizable action tags based on the domain and the context. The actions can be derived from a taxonomy of actions that are configured per domain.

Referring to FIG. 6, flowchart 600 provides an example methodology of an engine of the present disclosure for performing Conversational Understanding to identify high value transactional events, according to some embodiments. An example engine for performing this methodology may be the network-based system 105, or other specially programmed computer system configured to analyze millions of human communications in real time or near-real time.

At block 605, the engine may first access a plurality of human communications. The human communications may be written or verbal recorded communications from a variety of sources, such as social media messages. There may be thousands or even millions of these communications, according to some embodiments. In some embodiments, these communications are ingested in real time or near real time. Finding the high value transactions may be of relevance only if they can be acted upon in a time-sensitive manner.

At block 610, the engine may then evaluate each human communication for relevance to an industry-specific domain. Examples of these industry-specific domains are a travel domain, a movie domain, a fashion accessory domain, restaurants, the auto industry, and the like. The engine may utilize NLP, ML, and/or UHRS to determine which communication falls within the desired industry-specific domain. The domain may be specified by a user of the engine, such as users 122 or 132. In some embodiments, if the human communication is not relevant to the industry-specific domain, that message is discarded and/or ignored, and no further analysis is performed on it.

At block 615, the engine may then evaluate each human communication that is validly within the industry-specific domain for additional contextual information, such as an expression of intent to make a purchase. The engine may utilize NLP, ML, and/or UHRS to make this determination. Often times, most messages may not be specific enough to express such intent to make a purchase, and so the number of human communications to continue evaluating drops precipitously. For example, the engine may have been trained to distinguish between communications that express an intent or desire to make a purchase and communications that merely state opinions or judgements about a particular topic. As another example, an intent or desire to make a purchase may be worded differently than a communication making an argument or trying to state a line of reasoning about a particular topic. In general, the mining process for obtaining specific communications with likely intent to purchase may result in a small percentage of communications actually being considered valid.

At block 620, the engine may then evaluate each human communication that qualifies as signaling an intent to purchase for additional contextual information, such as a purchase time frame. The engine may utilize NLP, ML, and/or UHRS to make this determination. A valid time frame may be based on user settings. For example, the user may want to eliminate all communications expressing that a purchase has already been made.

At block 625, may then evaluate each human communication that falls within a valid purchase time for additional contextual information, such as a particular geographic location. The engine may utilize NLP, ML, and/or UHRS to make this determination. The user of the engine may seek communications only within an area that the user can feasibly conduct business, such as if the user must physically travel to locations in order to provide their service.

This additional contextual information in blocks 615, 620, and 625 may act as filters for mining only specific human communications that are more likely to be acted upon, thereby identifying the high value transactional events. While this example methodology is described as evaluating each filter in a particular sequence, other methods may perform the evaluations in a different order, and embodiments are not so limited. In general, each contemplated method performs each of these filtering processes in a sequence, such that fewer and fewer communications are evaluated after each progressive step. In addition, in some embodiments, other contextual filters may be applied, such as different sizes of geographical areas (e.g., what county/province, what state/region, what country, etc.), age, frequency of use of the user account, how many followers or friends, etc.

For any communications successfully satisfying each of the criteria in blocks 610, 615, 620, and 625, at block 630, the engine may cause display of each of these communications as being a high value transactional event. In some embodiments, various data is shown about the communication, such as the actual message body, a link to the original message, a category according to a taxonomy about what type of purchase intent the message conveyed, the industry domain(s), what time frame the desired purchase is for, geographic location, the author of the message, and the like. This information may then be acted upon by a user of the engine, such as a marketing manager or a sales representative intending to communicate directly with the author of the communication.

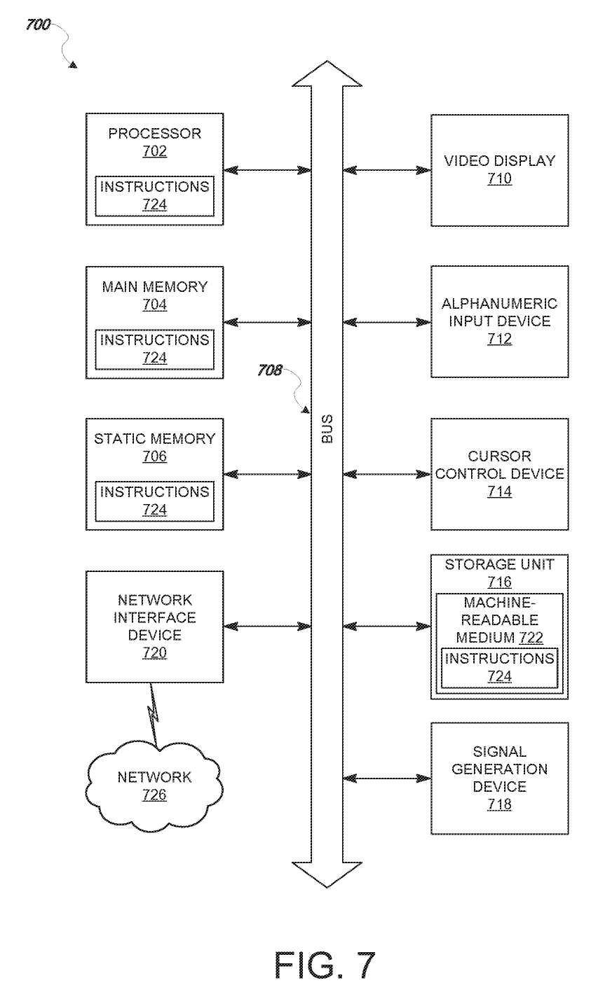

Referring to FIG. 7, the block diagram illustrates components of a machine 700, according to some example embodiments, able to read instructions 724 from a machine-readable medium 722 (e.g., a non-transitory machine-readable medium, a machine-readable storage medium, a computer-readable storage medium, or any suitable combination thereof) and perform any one or more of the methodologies discussed herein, in whole or in part. Specifically, FIG. 7 shows the machine 700 in the example form of a computer system (e.g., a computer) within which the instructions 724 (e.g., software, a program, an application, an applet, an app, or other executable code) for causing the machine 700 to perform any one or more of the methodologies discussed herein may be executed, in whole or in part.

In alternative embodiments, the machine 700 operates as a standalone device or may be connected (e.g., networked) to other machines. In a networked deployment, the machine 700 may operate in the capacity of a server machine 110 or a client machine in a server-client network environment, or as a peer machine in a distributed (e.g., peer-to-peer) network environment. The machine 700 may include hardware, software, or combinations thereof, and may, as example, be a server computer, a client computer, a personal computer (PC), a tablet computer, a laptop computer, a netbook, a cellular telephone, a smartphone, a set-top box (STB), a personal digital assistant (PDA), a web appliance, a network router, a network switch, a network bridge, or any machine capable of executing the instructions 724, sequentially or otherwise, that specify actions to be taken by that machine. Further, while only a single machine 700 is illustrated, the term “machine” shall also be taken to include any collection of machines that individually or jointly execute the instructions 724 to perform all or part of any one or more of the methodologies discussed herein.

The machine 700 includes a processor 702 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 704, and a static memory 706, which are configured to communicate with each other via a bus 708. The processor 702 may contain microcircuits that are configurable, temporarily or permanently, by some or all of the instructions 724 such that the processor 702 is configurable to perform any one or more of the methodologies described herein, in whole or in part. For example, a set of one or more microcircuits of the processor 702 may be configurable to execute one or more modules (e.g., software modules) described herein.

The machine 700 may further include a video display 710 (e.g., a plasma display panel (PDP), a light emitting diode (LED) display, a liquid crystal display (LCD), a projector, a cathode ray tube (CRT), or any other display capable of displaying graphics or video). The machine 700 may also include an alphanumeric input device 712 (e.g., a keyboard or keypad), a cursor control device 714 (e.g., a mouse, a touchpad, a trackball, a joystick, a motion sensor, an eye tracking device, or other pointing instrument), a storage unit 716, a signal generation device 718 (e.g., a sound card, an amplifier, a speaker, a headphone jack, or any suitable combination thereof), and a network interface device 720.

The storage unit 716 includes the machine-readable medium 722 (e.g., a tangible and non-transitory machine-readable storage medium) on which are stored the instructions 724 embodying any one or more of the methodologies or functions described herein, including, for example, any of the descriptions of FIGS. 1-6. The instructions 724 may also reside, completely or at least partially, within the main memory 704, within the processor 702 (e.g., within the processor's cache memory), or both, before or during execution thereof by the machine 700. The instructions 724 may also reside in the static memory 706.

Accordingly, the main memory 704 and the processor 702 may be considered machine-readable media 722 (e.g., tangible and non-transitory machine-readable media). The instructions 724 may be transmitted or received over a network 726 via the network interface device 720. For example, the network interface device 720 may communicate the instructions 724 using any one or more transfer protocols (e.g., HTTP). The machine 700 may also represent example means for performing any of the functions described herein, including the processes described in FIGS. 1-6.

In some example embodiments, the machine 700 may be a portable computing device, such as a smart phone or tablet computer, and have one or more additional input components (e.g., sensors or gauges) (not shown). Examples of such input components include an image input component (e.g., one or more cameras), an audio input component (e.g., a microphone), a direction input component (e.g., a compass), a location input component (e.g., a GPS receiver), an orientation component (e.g., a gyroscope), a motion detection component (e.g., one or more accelerometers), an altitude detection component (e.g., an altimeter), and a gas detection component (e.g., a gas sensor). Inputs harvested by any one or more of these input components may be accessible and available for use by any of the modules described herein.

As used herein, the term “memory” refers to a machine-readable medium 722 able to store data temporarily or permanently and may be taken to include, but not be limited to, random-access memory (RAM), read-only memory (ROM), buffer memory, flash memory, and cache memory. While the machine-readable medium 722 is shown in an example embodiment to be a single medium, the term “machine-readable medium” should be taken to include a single medium or multiple media (e.g., a centralized or distributed database 115, or associated caches and servers) able to store instructions 724. The term “machine-readable medium” shall also be taken to include any medium, or combination of multiple media, that is capable of storing the instructions 724 for execution by the machine 700, such that the instructions 724, when executed by one or more processors of the machine 700 (e.g., processor 702), cause the machine 700 to perform any one or more of the methodologies described herein, in whole or in part. Accordingly, a “machine-readable medium” refers to a single storage apparatus or device 120 or 130, as well as cloud-based storage systems or storage networks that include multiple storage apparatus or devices 120 or 130. The term “machine-readable medium” shall accordingly be taken to include, but not be limited to, one or more tangible (e.g., non-transitory) data repositories in the form of a solid-state memory, an optical medium, a magnetic medium, or any suitable combination thereof.

Furthermore, the machine-readable medium 722 is non-transitory in that it does not embody a propagating signal. However, labeling the tangible machine-readable medium 722 as “non-transitory” should not be construed to mean that the medium is incapable of movement; the medium should be considered as being transportable from one physical location to another. Additionally, since the machine-readable medium 722 is tangible, the medium may be considered to be a machine-readable device.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute software modules (e.g., code stored or otherwise embodied on a machine-readable medium 722 or in a transmission medium), hardware modules, or any suitable combination thereof. A “hardware module” is a tangible (e.g., non-transitory) unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor 702 or a group of processors 702) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor 702 or other programmable processor 702. It will be appreciated that the decision to implement a hardware module mechanically, in dedicated and permanently configured circuitry, or in temporarily configured circuitry (e.g., configured by software) may be driven by cost and time considerations.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses 708) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors 702 that are temporarily configured (e.g., by software) or permanently configured to perform the relevant operations. Whether temporarily or permanently configured, such processors 702 may constitute processor-implemented modules that operate to perform one or more operations or functions described herein. As used herein, “processor-implemented module” refers to a hardware module implemented using one or more processors 702.

Similarly, the methods described herein may be at least partially processor-implemented, a processor 702 being an example of hardware. For example, at least some of the operations of a method may be performed by one or more processors 702 or processor-implemented modules. As used herein, “processor-implemented module” refers to a hardware module in which the hardware includes one or more processors 702. Moreover, the one or more processors 702 may also operate to support performance of the relevant operations in a “cloud computing” environment or as a “software as a service” (SaaS). For example, at least some of the operations may be performed by a group of computers (as examples of machines 700 including processors 702), with these operations being accessible via a network 726 (e.g., the Internet) and via one or more appropriate interfaces (e.g., an API).

The performance of certain operations may be distributed among the one or more processors 702, not only residing within a single machine 700, but deployed across a number of machines 700. In some example embodiments, the one or more processors 702 or processor-implemented modules may be located in a single geographic location (e.g., within a home environment, an office environment, or a server farm). In other example embodiments, the one or more processors 702 or processor-implemented modules may be distributed across a number of geographic locations.

Unless specifically stated otherwise, discussions herein using words such as “processing,” “computing,” “calculating,” “determining,” “presenting,” “displaying,” or the like may refer to actions or processes of a machine 700 (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

The present disclosure is illustrative and not limiting. Further modifications will be apparent to one skilled in the art in light of this disclosure and are intended to fall within the scope of the appended claims.

What is claimed is:

1. A method for determining a high value transactional event communication, the method comprising:
accessing, by an artificial intelligence engine, a plurality of human communications streaming in real time or near-real time;
evaluating, by the artificial intelligence engine, each human communication among the plurality of human communications for relevance to an industry-specific domain;
evaluating, by the artificial intelligence engine, each human communication that is relevant to the industry-specific domain for an expression of intent to conduct a monetary transaction; and
causing display of each human communication that is relevant to the industry-specific domain and satisfies a valid expression of intent to conduct a monetary transaction.

2. The method of claim 1, further comprising discarding, from further evaluation, by the artificial intelligence engine, each human communication that is determined to not be relevant to the industry-specific domain.

3. The method of claim 1, further comprising discarding, from further evaluation, by the artificial intelligence engine, each human communication that is determined to not express an intent to conduct a monetary transaction.

4. The method of claim 1, further comprising evaluating, by the artificial intelligence engine, each human communication that satisfies a valid expression of intent to conduct a monetary transaction for a purchase time frame indicating an approximate time period for when the monetary transaction is intended to be conducted; and
wherein causing the display of each human communication is based further on each human communication satisfying a valid purchase time frame.

5. The method of claim 4, further comprising discarding, from further evaluation, by the artificial intelligence engine, each human communication that is determined to not satisfy a valid purchase time frame.

6. The method of claim 1, further comprising evaluating, by the artificial intelligence engine, each human communication that satisfies a valid expression of intent to conduct a monetary transaction for a geographic location indicating an approximate geographic location for where the monetary transaction is intended to be conducted; and
wherein causing the display of each human communication is based further on each human communication satisfying a valid geographic location.

7. The method of claim 1, further comprising discarding, from further evaluation, by the artificial intelligence engine, each human communication that is determined to not express a valid geographic location.

8. An apparatus for determining a high value transactional event communication, the apparatus comprising a memory and a processor communicatively coupled to the memory, the processor configured to:
access a plurality of human communications streaming in real time or near-real time;
evaluate each human communication among the plurality of human communications for relevance to an industry-specific domain;
evaluate each human communication that is relevant to the industry-specific domain for an expression of intent to conduct a monetary transaction; and
cause display of each human communication that is relevant to the industry-specific domain and satisfies a valid expression of intent to conduct a monetary transaction.

9. The apparatus of claim 8, wherein the processor is further configured to discard from further evaluation, each human communication that is determined to not be relevant to the industry-specific domain.

10. The apparatus of claim 8, wherein the processor is further configured to discard from further evaluation, each human communication that is determined to not express an intent to conduct a monetary transaction.

11. The apparatus of claim 8, wherein the processor is further configured to evaluate each human communication that satisfies a valid expression of intent to conduct a monetary transaction for a purchase time frame indicating an approximate time period for when the monetary transaction is intended to be conducted; and
wherein causing the display of each human communication is based further on each human communication satisfying a valid purchase time frame.

12. The apparatus of claim 11, wherein the processor is further configured to discard from further evaluation, each human communication that is determined to not satisfy a valid purchase time frame.

13. The apparatus of claim 8, wherein the processor is further configured to evaluate each human communication that satisfies a valid expression of intent to conduct a monetary transaction for a geographic location indicating an approximate geographic location for where the monetary transaction is intended to be conducted; and
wherein causing the display of each human communication is based further on each human communication satisfying a valid geographic location.

14. The apparatus of claim 13, wherein the processor is further configured to discard from further evaluation, each human communication that is determined to not express a valid geographic location.
